(19) United States
(12) Patent Application Publication
(10) Pub. No.: US 2025/0300401 A1
(43) Pub. Date: Sep. 25, 2025

(54) RETAINER DEVICE AND METHOD FOR DATA CONNECTORS

(71) Applicant: Everi Games Inc., Austin, TX (US)

(72) Inventors: Lawrence J. Knipp, Austin, TX (US); Jose Avila, Pflugerville, TX (US); Brian Villalobos, Austin, TX (US); Gregory Longendyke, Dripping Springs, TX (US); Eduard Kliger, Austin, TX (US); Henry McDonald, Leander, TX (US)

(73) Assignee: Everi Games Inc., Austin, TX (US)

(21) Appl. No.: 18/616,099

(22) Filed: Mar. 25, 2024

(51) Int. Cl. H01R 13/639

(52) U.S. Cl. CPC H01R 13/639

(57) ABSTRACT

A retainer device includes a mounting base, a connector receiver, and a resilient connecting member connected between the mounting base and the connector receiver. A mounting feature is connected to the mounting base and is adapted to connect the mounting base to a structure adjacent to a data connector of an electronic device. The connector receiver is adapted for receiving a linking data connector through an access structure to a received position in which a surface of the connector receiver abuts a surface of the linking data connector for applying a retaining force to the linking data connector in a direction from the connector receiver toward the mounting base.

### TECHNICAL FIELD OF THE INVENTION

The invention relates to connectors used in data communications between electronic components, and, more particularly, to retainer devices for helping to hold such a connector in an operatively connected position on an electronic device. The invention has particular application in modern gaming machines.

### BACKGROUND OF THE INVENTION

Modern gaming machines commonly include numerous electronic components that must communicate with each other and/or with a main processor or processing system that controls the conduct of games offered through the gaming machine. Modern high-speed serial data communications are frequently used to provide communications between the main gaming machine processing system and various peripheral systems such as mechanical reel controllers, keyboards, touchscreen controllers for video display devices, card and ticket readers, ticket printers, and accent lighting controllers, for example. These communications are conveniently accomplished through communication standards such as Universal Serial Bus (USB) which specify both communication protocols and physical interfaces. The physical interface specifications include standard connector types such as USB Type-A and USB Type-B connectors in various forms, and the current USB Type-C connector, which is shared with the DisplayPort standard for connection to video display devices. Typically, the desired connection is made through a cable having a standard male connector according to one of the specified connector types which is inserted into a corresponding receptacle of a connector socket mounted on the electronic component.

Standard connectors such as the USB connector types are designed for ease of use, particularly in a consumer electronics setting. The design allows the user to produce the desired connection between two electronic components simply by plugging the standard connector at one end of the cable into a corresponding connector of the first electronic component (such as a printer for example) and plugging the standard connector at the opposite end of the cable into a corresponding connector of the second electronic component (such as a personal computer for example). While the standard connector types are ideal in terms of ease of use, they can present issues in certain applications such as applications within gaming machines. In particular, while the connections themselves are typically contained within various housings of the gaming machine and thus not exposed to users, the connections are subject to vibration from the operation of mechanical devices on the gaming machine such as spinning reels and/or wheels and also various fans needed for thermal control of electronic components. Vibrations from operation or handling of a gaming machine may cause a standard connector such as a USB connector to dislodge from the desired operatively connected position to a position in which electrical contacts separate either completely or intermittently to prevent proper operation of the gaming machine. This is particularly problematic in a gaming machine in which significant prizes may be available in a game conducted through the gaming machine. A failure of the gaming machine to operate properly due to a loose or completely disconnected data connector may lead to damage claims from a player who has had a play interrupted due to the disconnection or loose connection.

### SUMMARY OF THE INVENTION

It is an object of the invention to provide a retainer device and retention method for use particularly with standard data connectors to facilitate a more robust connection that is less likely to disconnect to an inoperative state.

A retainer device according to one aspect of the present invention includes a mounting base, a connector receiver, and a resilient connecting member connected between the mounting base and the connector receiver. A mounting feature is connected to the mounting base and is adapted to connect the mounting base to a structure adjacent to a data connector of an electronic device. The connector receiver is adapted for receiving a corresponding linking data connector through an access structure to a received position in which a surface of the connector receiver abuts a surface of the linking data connector for applying a retaining force to the linking data connector in a direction from the connector receiver toward the mounting base. When the mounting base is secured to a surface of an electronic device having a data connector such as connector socket, the retaining force may be used to help hold a linking data connector in an operatively connected position with the data connector receiving socket and prevent the plug end of the linking data connector from inadvertently disconnecting from the socket due to vibration or other mechanical forces acting on the electronic device.

As used in this disclosure and the accompanying claims, the expression “linking data connector” refers to a device that includes a standardized connector at one end adapted to form an operative data connection with a corresponding standardized connector. Typically, the standardized connector of the linking data connector will include a male plug end and the corresponding standardized connector will be a female connector having a socket for receiving the male plug end. A linking data connector will commonly include a connector cord that terminates at one end at the standardized male plug end. A protective boot may be included to cover and protect the connections that are needed between conductors included in the cord and terminals of the standardized male plug end.

The mounting feature may include a retainer post protruding from a bottom surface of the mounting base, and in some cases, multiple retaining posts spaced apart along the bottom surface of the mounting base. In some implementations, each retaining post comprises an elongated structure with a proximal end connected to the mounting base, a distal end section opposite to the proximal end section, and an intermediate section located between the proximal end section and distal end section. The distal end section may have a larger maximum transverse cross-sectional dimension than the intermediate section. At least the distal end section is resiliently compressible in a direction transverse to a longitudinal axis of the distal end section to facilitate inserting the retainer post into an opening as will be discussed below. In alternate forms, a retainer post may or may not include an enlarged distal end section and may be resiliently compressible along its entire length in directions transverse to the longitudinal axis of the retainer post.

In some implementations the connector receiver includes a receiver body having a linking data connector receiving passage formed therethrough. In these implementations the access structure comprises an access slot extending from an edge of the receiver body to the linking data connector receiving passage. The access slot here has a width dimension less than a width dimension of the data connector receiving passage but may be manipulated to allow the data connector to be received in the linking data connector receiving passage. For example, the access slot may be formed between two arms of the receiver body and at least the two arms are formed from a resiliently bendable material so that width dimension of the access slot may be resiliently spread apart to accept a portion of the linking data connector therethrough when aligned in a length direction of the access slot. Some embodiments of the receiver body may include a receiver recess aligned with the linking data connector receiving passage to receive a portion of the plug end of the data connector.

A retainer device according to a second aspect of the invention includes a mounting base and a mounting feature similar to the previously described retainer devices. However, a retainer device according to the second aspect of the invention does not include a connector receiver and connecting member. Rather, this alternate type of retainer device includes a strap receiving structure located at a part of the mounting base other than the mounting base bottom surface. This strap receiving structure provides a connecting point for a resilient strap. In use, the mounting base according to this second aspect of the invention may be secured to an electronic device at a location adjacent to a data connector of the electronic device. Once the connector of a linking data connector is placed in the operative position relative to the data connector of the electronic device, a resilient strap of material may be secured at one end to the strap receiving structure of the mounting base and the opposite end of the resilient strap looped around the data connector to apply a retaining force to the data connector.

Another aspect of the invention includes methods for retaining a linking data connector in an operative position in a corresponding data connector of an electronic device. These methods will be described below in connection with the example embodiments shown in the figures.

These and other aspects, advantages, and features of the invention will be apparent from the following description of representative embodiments, considered along with the accompanying drawings.

### BRIEF DESCRIPTION OF THE DRAWINGS

FIG. 1 is an isometric view of a retainer device according to a first embodiment of the present invention.

FIG. 2 is a top view of the retainer device shown in FIG. 1

FIG. 3 is a left side view of the retainer device shown in FIG. 1

FIG. 4 is a connector receiver end view of the retainer device shown in FIG. 1.

FIG. 5 is a somewhat schematic longitudinal section view of the retainer device shown in FIG. 1 mounted in an operating position on an electronic device and retaining a linking data connector operatively connected with a corresponding data connector on the electronic device.

FIG. 6 is an isometric view of a retainer device according to a second embodiment of the invention.

FIG. 7 is a top view of the retainer device shown in FIG. 6.

FIG. 8 is a side view of the retainer device shown in FIG. 6.

FIG. 9 is a bottom view of the retainer device shown in FIG. 6.

FIG. 10 is an isometric view of the retainer device shown in FIG. 6 in an operating position on an electronic device and cooperating with a resilient band to hold a linking data connector in an operatively connected position relative to a corresponding data connector on the electronic device.

### DESCRIPTION OF REPRESENTATIVE EMBODIMENTS

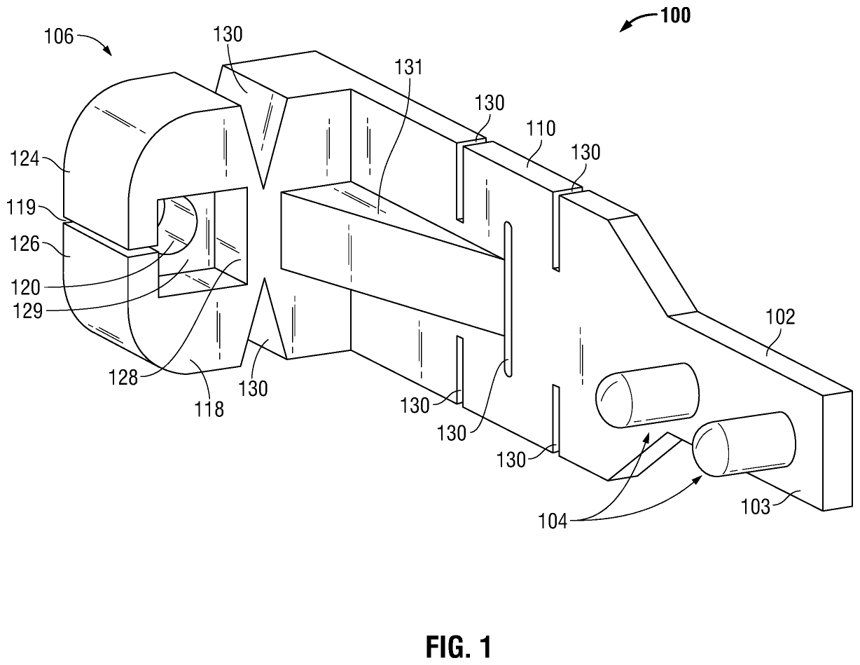

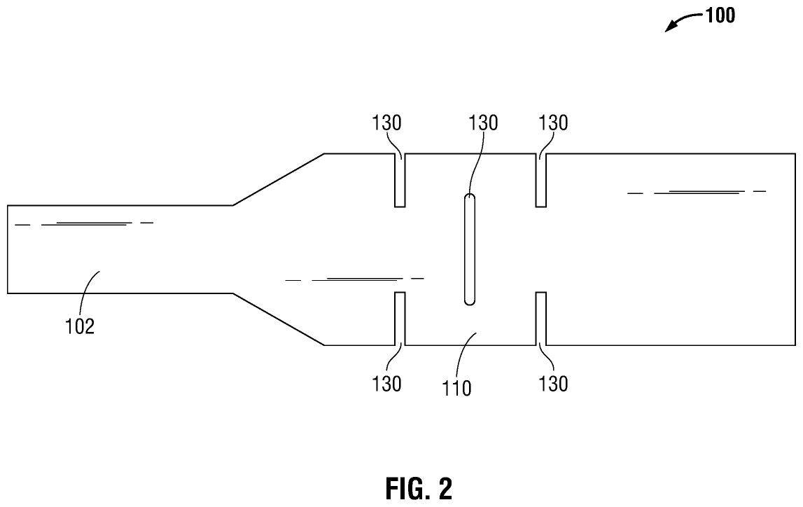

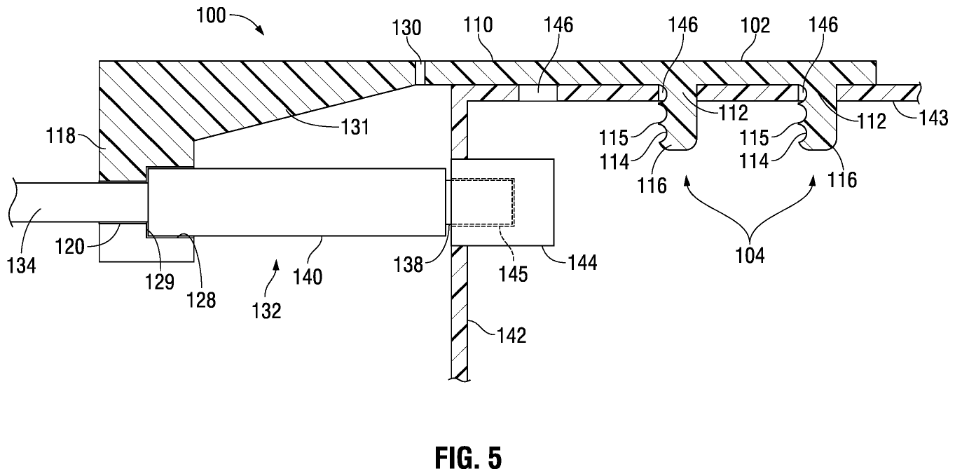

Referring to FIG. 1, an example retainer device 100 includes a mounting base 102 and a connector receiver 106 connected together by a connecting member 110. As will be described with reference to FIG. 5 below, mounting base 102 may be secured to an electronic device in position to allow connector receiver 106 to help retain a linking data connector in an operatively connected position with a data connector of the electronic device.

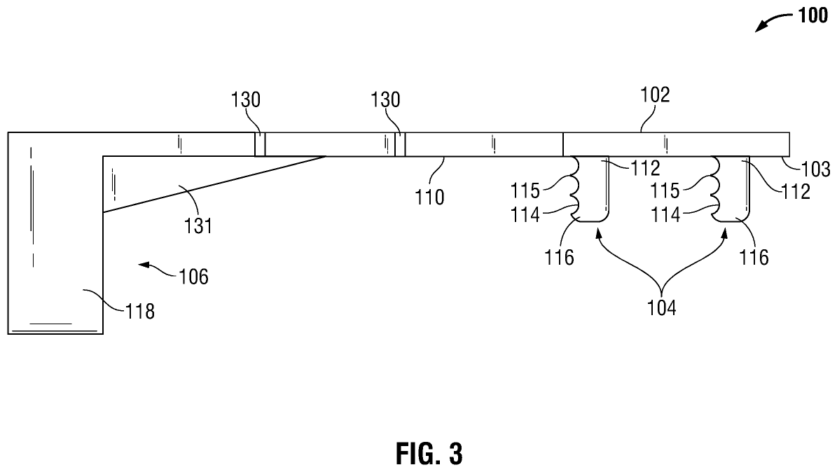

Mounting base 102 includes a bottom surface 103 having a mounting feature which in this embodiment comprises multiple retainer posts 104. As best shown in the side view of FIG. 3 each retainer post 104 in this example embodiment has an elongated body and includes a post proximal end 112 and a post distal end 116 separated by an intermediate section 114. The intermediate section 114 has a smaller cross-section than the post distal end 116. As will be described below in connection with FIG. 5 this arrangement of intermediate section 114 and relatively larger post distal end 116 combined with the transversely compressible material from which distal end 116 is formed helps the respective retainer post 104 stay in a connected or operating position on an electronic device with which the retainer device 100 is used. It will be noted that each of the retainer posts 104 in example retainer device 100 includes multiple relatively narrower sections in addition to the narrow intermediate section called out at reference numeral 114. Each of these relatively narrower sections (narrower as compared to the post distal end 116) is separated by a ridge 115. This arrangement of multiple narrow intermediate sections may help enhance the connection to the electronic device as will be described further below in connection with FIG. 5.

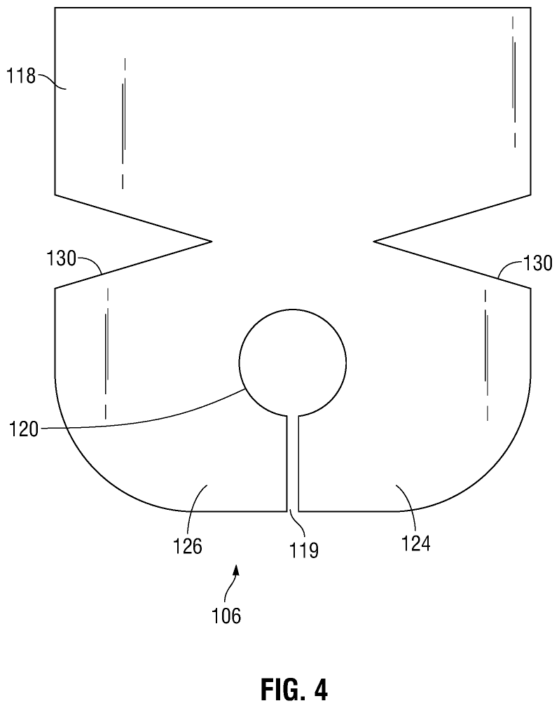

As shown in FIGS. 1 and 3-5, connector receiver 106 comprises a receiver body 118 and an access structure which in this case comprises a slot 119 (slot 119 shown in FIGS. 1 and 4). As will be described below in connection with FIG. 5, slot 119 provides access for placing a linking data connector in a position extending through a linking data connector receiving passage 120 formed in receiver body 118. In the example embodiment of retainer device 100, slot 119 separates two arms 124 and 126 (shown FIGS. 1 and 4) of the receiver body 118 which may be spread apart to allow a portion of a linking data connector to be inserted into linking data connector receiving passage 120. The receiver body 118 of the example retainer device 100 also includes a receiver recess 128 (shown in FIGS. 1 and 5) that is aligned with linking data connector receiving passage 120 and faces in the direction in which connector member 110 extends from receiver body 118.

Retainer device 100 further includes a number of strain relief structures 130 formed both in connecting member 110 and receiver body 118. As shown in FIG. 1 and the views of FIGS. 3 and 5, retainer device 100 also includes a reinforcing structure 131 connecting receiver body 118 and connecting member 110.

Although the various components of retainer device 100 may be formed separately and connected together by a suitable connecting arrangement, the example retainer device 100 may be conveniently formed monolithically, for example, in a molding process or in an additive manufacturing process. The entire retainer device 100 may be formed from a suitable resilient material to facilitate the various functions described below particularly in connection with FIG. 5.

Referring now to FIG. 5, retainer device 100 is shown in longitudinal section taken approximately along the longitudinal center axis of the device. FIG. 5 also shows a portion of a housing for an electronic device which includes a wall 142 and a wall 143. Wall 142 includes a schematically represented data connector in this case comprising a female connector such as a female USP type A female connecter shown schematically as a box at 144. Data connector 144 includes a receptacle 145 shown in dashed lines and having a receptacle opening facing to the left in the orientation of FIG. 5. Wall 143 of the electronic device includes a number of openings 146 which may, for example, be air circulation openings formed in the material of wall 143.

FIG. 5 also shows a linking data connector 132 that includes a cord 134, a male connector plug 138, and a connector boot 140. Although the connections are not shown in FIG. 5, it will be appreciated that the standard linking data connector 132 includes various conductors within cord 134 that terminate within connector boot 140 and are connected to contacts associated with a male connector plug 138. FIG. 5 shows male connector plug 138 of linking data connector 132 extending into receptacle 145 of data connector 144. This position of linking data connector 132 relative to data connector 144 represents an operating position with an operative connection between the linking data connector and data connector 144.

Referring still to FIG. 5, retainer device 100 has been positioned on wall 143 of the electronic device with each retainer post 104 extending into a respective one of the openings 146 formed in wall 143. In the example embodiment where the retainer posts 104 are formed from a transversely compressible material, it will be appreciated from FIG. 5 that post distal end 116 must be compressed slightly in a direction transvers to the longitudinal axis of the respective retainer post 104 in order to fit the distal end 116 through the narrower opening 146. The resilient material from which each retainer post 104 is formed resiliently returns to its uncompressed position once passing through the opening 146 to help retain the respective retainer post 104 in the inserted position shown in FIG. 5. FIG. 5 also shows that linking data connector 132 has been positioned relative to retainer device 100 with the cord 134 extending through linking data connector receiving passage 120 and with the left end of boot 140 received in receiver recess 128. In this position a base surface 129 of receiver recess 128 may contact the left end of connector boot 140 to apply a retention force in the direction from the receiver body 118 towards data connector 144 and the receptacle 145 contained therein. Thus in the position shown in FIG. 5, retainer device 100 serves to retain linking data connector 132 in its operatively connected position in the electronic device data connector 144 and helps prevent male connector plug 138 from being inadvertently removed from the receptacle 145 either by inadvertent contact or through vibration of the electronic device including data connector 144.

Numerous variations from retaining device 100 are possible within the scope of the present invention. For example, although receiver body 118 protrudes from one side of the device to form an L shape with connector member 110 and mounting base 102, other configurations are possible. Alternate configurations may include two separate connector straps connecting on two opposing sides of a receiver body such as receiver body 118. Each of these alternate connector straps may be connected to a respective mounting base similar to mounting base 102. According to other alternate forms, mounting base 102 may include more than two or only one retainer post such as retainer post 104. Where multiple retainer posts are present, the retainer posts may be formed of a material at least at the proximal end 112 that may be readily severed so that the retainer post may be removed if it does not align with an opening such as opening 146 (shown in FIG. 5) on the electronic device. Regardless of the number of retainer posts, the retainer posts need not include an enlarged distal end such as distal end 116. Rather, each retainer post may have a uniform shape along its length and may be transversely compressible along the entire length. Additionally, although a receiver recess such as receiver recess 128 may be provided on a receiver body in accordance with the present invention for receiving a portion of a connector plug boot such as boot 140, such a receiver recess may be omitted in some implementations.

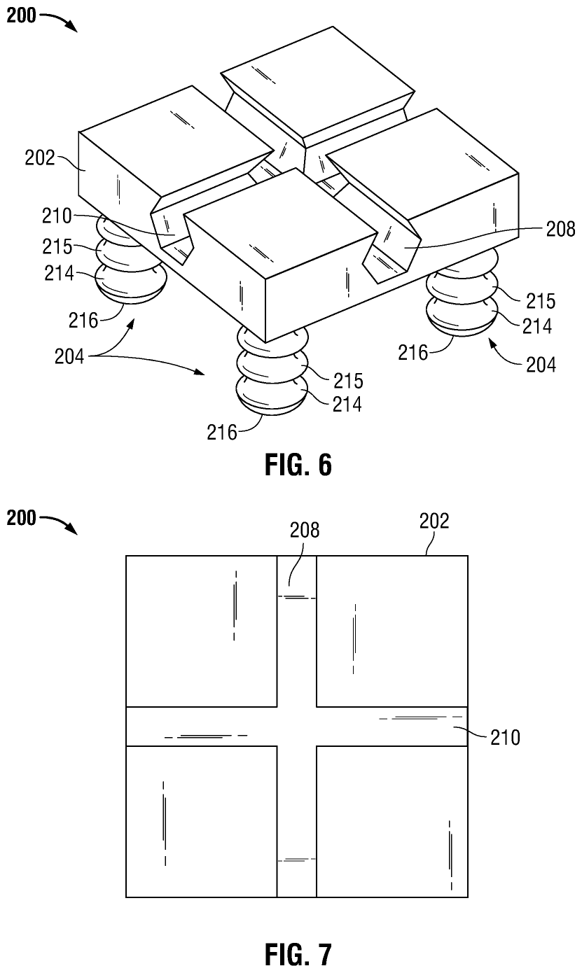

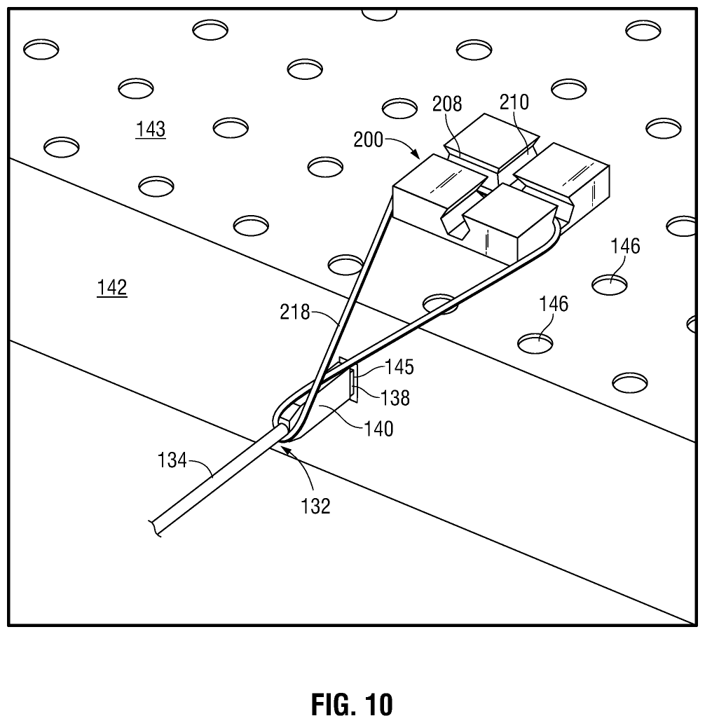

FIGS. 6-10 show a retainer device 200 according to a second embodiment of the invention. This particular embodiment dispenses with a connector member such as the connector member 110 shown in FIG. 1 and a connector receiver such as connector receiver 106 shown in FIG. 1. Rather, retainer device 200 relies on a separate strap for retaining a linking data connector in an operatively connected position on an electronic device. The use of retainer device 200 and a suitable strap will be described below in connection with FIG. 10.

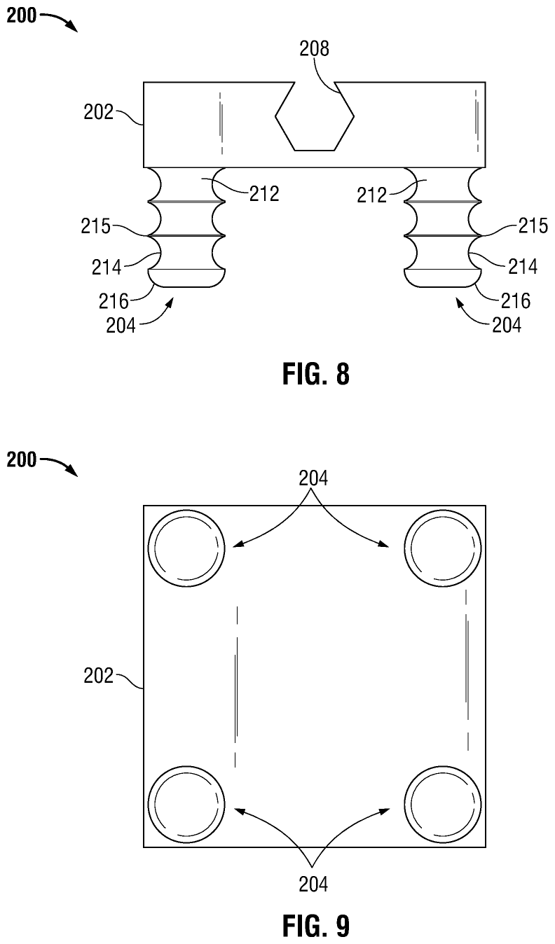

Referring to FIG. 6, retainer device 200 includes a mounting base 202 and a mounting feature which in this case comprises four retainer posts 204 (three of which are visible in the view of FIG. 6). An upper side of mounting base 202 includes a strap receiving structure which in this case is formed from two grooves 208 and 210 which intersect each other at right angles. As shown in FIGS. 6 and 8, retainer posts 204 are elongated structures similar to retainer posts 104 shown in the embodiment of FIG. 1 with a distal end 216, proximal end 212, and intermediate section 214. However in the example of retainer post 204, the narrow portions of intermediate section 214 extend circumferentially around the entire post as does the intermediate section ridges 215.

FIG. 10 shows retainer device 200 in a connected position relative the electronic device having walls 142 and 143 (the same electronic device shown in FIG. 5). In this position each retainer post 204 has been inserted through a respective opening 146 in electronic device wall 143 to secure mounting base 202 to the electronic device. FIG. 10 also shows that linking data connector 132 has been positioned in the operatively connected position with male connector plug 138 and inserted into receptacle 145 of the data connector associated with the electronic device (shown as 144 in FIG. 5 but covered by wall 142 in the view of FIG. 10). With mounting base 202 secured to the electronic device and linking data connector 132 operatively connected to the electronic device, a strap 218 preferably comprising a band of elastomeric material has been wrapped around the strap receiving structure formed on mounting base 202 with the opposite end of the strap wrapped around connector boot 140 of linking data connector 132. The elastomeric strap biases male connector plug 138 toward the connector receptacle 145 to retain linking data connector 132 in the operatively connected position.

As with retainer device 100, retainer device may be monolithically formed such as by an additive manufacturing process or by molding. Although the intersecting grooves 208 and 210 provide a convenient strap receiving structure, the strap receiving structure may comprise any suitable arrangement that provides a location for receiving one end of the strap 218. As with retainer posts 104 shown on retainer device 100, retainer posts 204 are preferably constructed of material that allows them to be severed at the bottom surface of mounting base 202. This allows retainer posts 204 to be removed as needed in the event they do not line up with an opening such as openings 146 on the electronic device.

Retainer devices in accordance with aspects of the present invention may include additional variations from the example retainer device 100 shown in FIG. 1 and example retainer device 200 shown in FIG. 10. For example a retainer post need not include a resilient material that is compressed as the retainer post is inserted into an opening (such as openings 146 in FIGS. 5 and 10). In alternative forms within the scope of the present invention and the following claims, a retainer post may comprise either a rigid on non-rigid member that is adapted to extend loosely or otherwise into an opening, such as opening 146 for example, and catch on an edge of the opening. In these cases, the retainer post may be linear or curved and may extend transversely with respect to a structure representing a mounting base either at an end of that mounting base structure or at some point spaced apart from an end of that structure. A linear retainer post in these alternatives may extend at an acute angle from the structure representing the mounting base. As with either of the example retainer device 100 or retainer device 200, the element comprising the mounting base in these alternative retaining devices serves as a way to connect the retainer post to a resilient strap such as strap 218 shown in FIG. 10 or connector member 110 shown for example in FIG. 5. Alternative retainer devices using this hook-type retainer post may dispense with a connector receiver such as 106 shown in FIG. 1 and rely on a resilient strap such as strap 218 for connection to the linking data connector. Alternative retainer devices using this hook-type retainer post may, rather than relying on a resilient strap such as strap 218, include a connector receiver such as connector receiver 106 or the variations on that element as described above.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A retainer device for retaining a linking data connector in an operatively connected position with a data connector of an electronic device, the retainer device including:
(a) a mounting base;
(b) a mounting feature connected to the mounting base and adapted to connect the mounting base to a structure adjacent to a data connector of an electronic device;
(c) a connector receiver having an access structure;
(d) a resilient connecting member connected between the mounting base and the connector receiver; and
(e) wherein the connector receiver is adapted for receiving a linking data connector through the access structure to a received position in which a surface of the connector receiver abuts a surface of the linking data connector for applying a retaining force to the linking data connector in a direction from the connector receiver toward the mounting base.

2. The retainer device of claim 1 wherein the mounting feature includes a retainer post extending from the mounting base.

3. The retainer device of claim 2 wherein:
(a) the retainer post is elongated with a proximal end section connected to the mounting base, a distal end section opposite to the proximal end section, and an intermediate section located between the proximal end section and distal end section, the distal end section having a larger maximum transverse cross-sectional dimension than the intermediate section; and
(b) at least the distal end section is resiliently compressible in a direction transverse to a longitudinal axis of the distal end section.

4. The retainer device of claim 2 wherein the retainer post is elongated and is resiliently compressible in a direction transverse to a longitudinal axis of the retainer post.

5. The retainer device of claim 1 wherein:
(a) the mounting feature includes multiple retainer posts extending from a bottom surface of the mounting base, the multiple retainer posts each being elongated and being located at spaced apart locations on the bottom surface of the of the mounting base; and
(b) each retainer post is elongated and is resiliently compressible in a direction transverse to a longitudinal axis of the respective retainer post.

6. The retainer device of claim 1 wherein:
(a) the connector receiver includes a receiver body having a linking data connector receiving passage formed therethrough; and
(b) the access structure comprises an access slot extending from an edge of the receiver body to the linking data connector receiving passage.

7. The retainer device of claim 6 wherein the access slot has a width dimension less than a width dimension of the linking data connector receiving passage.

8. The retainer device of claim 7 wherein the access slot is formed between two arms of the receiver body and at least the two arms of the receiver body are formed from a resiliently bendable material so that the width dimension of the access slot is resiliently widenable to accept a portion of the linking data connector therethrough to reach the linking data connector receiving passage.

9. The retainer device of claim 7 wherein the mounting base, mounting feature, connector receiver, and resilient connecting member are all monolithically formed from a resilient material.

10. The retainer device of claim 6 wherein the receiver body includes a receiver recess aligned with the linking data connector receiving passage to receive a connector boot of the linking data connector.

11. The retainer device of claim 10 wherein the mounting base, mounting feature, connector receiver, and resilient connecting member are all monolithically formed from a resilient material.

12. The retainer device of claim 1 wherein the mounting base and resilient connecting member together form an elongated structure with the mounting base forming a proximal end thereof and the connector receiver includes a receiver body extending transversely at an end section of the resilient connecting member so that the mounting base, resilient connecting member and connector receiver form an L-shaped structure.

13. A retainer device for use in retaining a linking data connector in an operatively connected position with a data connector of an electronic device, the retainer device including:
(a) a mounting base defining a mounting base bottom surface;
(b) a mounting feature connected to the mounting base and adapted to connect the mounting base to a structure adjacent to a data connector of an electronic device; and
(c) a strap receiving structure located at a part of the mounting base other than the mounting base bottom surface, the strap receiving structure providing a connecting point for a resilient strap.

14. The retainer device of claim 13 wherein the mounting feature includes a retainer post extending from the mounting base bottom surface.

15. The retainer device of claim 14 wherein:
(a) the retainer post is elongated with a proximal end section connected to the mounting base, a distal end section opposite to the proximal end section, and an intermediate section located between the proximal end section and distal end section, the distal end section having a larger maximum transverse cross-sectional dimension than the intermediate section; and
(b) at least the distal end section is resiliently compressible in a direction transverse to a longitudinal axis of the distal end section.

16. The retainer device of claim 14 wherein the retainer post is elongated and is resiliently compressible in a direction transverse to a longitudinal axis of the retainer post.

17. The retainer device of claim 13 wherein:
(a) the mounting feature includes multiple retainer posts extending from the mounting base bottom surface, the multiple retainer posts each being elongated and being located at spaced apart locations on the mounting base bottom surface; and
(b) each retainer post is elongated and is resiliently compressible in a direction transverse to a longitudinal axis of the respective retainer post.

18. The retainer device of claim 17 wherein the mounting base, the mounting feature, and the strap receiving structure are monolithically formed.

19. A method of retaining a linking data connector in an operatively connected position with a data connector of an electronic device, the method including:
(a) inserting a retainer post through an opening on structure of the electronic device adjacent to the data connector, the retainer post extending from a mounting base so that inserting the retainer post through the opening on the structure of the electronic device releasably secures the mounting base to the structure of the electronic device;
(b) operatively connecting a linking data connector with the data connector of the electronic device; and
(b) securing a first end of a resilient strap to the linking data connector with a second end of the resilient strap secured to the mounting base so that the resilient strap applies a retention force in the direction from the linking data connector to the data connector of the electronic device.

20. The method of claim 19 wherein securing the first end of the resilient strap to the linking data connector includes sliding the linking data connector through a slot formed in a receiver body connected to the resilient strap.
